(19) United States
(12) Patent Application Publication
(10) Pub. No.: US 2016/0372155 A1
(43) Pub. Date: Dec. 22, 2016

(54) VIDEO BIT PROCESSING

(71) Applicants: Elmer Tolentino, JR., Livermore, CA (US); Curt Toppel, Manhattan Beach, CA (US); Gabriel Herscu, Livermore, CA (US)

(72) Inventors: Elmer Tolentino, JR., Livermore, CA (US); Curt Toppel, Manhattan Beach, CA (US); Gabriel Herscu, Livermore, CA (US)

(21) Appl. No.: 15/184,779

(22) Filed: Jun. 16, 2016

Related U.S. Application Data
(60) Provisional application No. 62/182,393, filed on Jun. 19, 2015.

(51) Int. Cl. G11B 27/034; G11B 27/36

(52) U.S. Cl. CPC G11B 27/034; G11B 27/36

(57) ABSTRACT

A video bit processing system accesses video content. The video bit processing system has components that operate on a server and on a personal computing device. The video bit processing system converts the video content to a format recognized by the personal computing device. The video bit processing system plays the converted video content on a display of the personal computing device. A video bit is created in response to a user selection performed by a user while the video content is playing. An end time for the video bit is based on a selection time in which the user makes the user selection. A beginning time for the video bit is at a time in the video that is a predetermined length of time before the end time.

Edited video clips or snippets are often made available to users for viewing. For example, to create an edited video clip from an original full length video, the full length video is often first converted into a format convenient for playing by a computing device. The converted video can then be accessed by a video editing tool that allows the converted video to be trimmed to produce a video clip. The video clip can be edited with video effects, sound track and so on, and then saved as a new file. Meta data such as names of people and places and dates can be added to a video file. The edited and saved video clip can then be transferred to a medium for distribution or viewing by a selected viewership. The medium used for distribution can be an online internet site, a mobile software application, a hard drive, a DVD, storage media, film and so on. Once transferred, the video clip is ready for on-demand viewing by anyone with access and/or authorization to view.

### BRIEF DESCRIPTION OF THE DRAWINGS

FIG. 1 is a simplified block diagram of a network architecture used to enable software controlled automation for converting, creating and distributing video bits in accordance with an implementation.

FIG. 2 is a functional flow diagram illustrating the converting, creating and distributing of video bits in accordance with an implementation.

FIG. 3 shows simplified logic flow for a process to convert, create and distribute video bits in accordance with an implementation.

FIG. 4 shows an example of a client-side application display screen used for converting, creating and distributing video bits in accordance with an implementation.

FIG. 5 is a simplified block diagram of a system architecture for an exemplary system that provides inputs for video media that interacts via system outputs with a client-side personal computing device used for converting, creating and distributing video bits in accordance with an implementation.

### DETAILED DESCRIPTION

With the popularization of mobile hand-held devices such as smart phones, available processing power and video recording capabilities allow users to perform many tasks pertaining to video capture, editing and distribution on mobile hand-held devices. For desktop computers, some of these tasks are becoming optimized. With the use of an external conversion system as described herein, digitally stored media and film can instantly interact with a computing-device video bit processing system. As such, the instant disclosure identifies and addresses a need for a software automated method for converting, creating, and distributing a video bit from a computing system. A video bit is a short video clip of predetermined length, for example, ten seconds.

As is described in greater detail below, the instant disclosure generally pertains to methods and systems for software automated conversion, creation and distribution of video bits from a computing system. In one example, video is captured and then converted into a format that can interact with a user's personal computing device (referred to as a client-side personal computing device). The captured video is made accessible to a user by a client-side video bit processing system. The video is played for the user. While the video plays, if the user makes a selection, a video bit is created. For example, the selection is made by the user performing a double-tap within a defined viewable area using the device's selection function, for example using a mouse, touch screen or keyboard. As a result of the selection, a video bit is created. An end time for the video bit is based on the point in the video where the user selection is made. For example, the end time is at the point in the video where the user made the selection. Alternatively, the end time for the video bit is a predetermined amount of time before or after the user made the selection. For example, the end time is two seconds before or two seconds after the user made the selection. The beginning of the video bit occurs at a predetermined amount of time before the end time. For example, the predetermined times are user adjustable. For example, a default value for the predetermined time used to determine the beginning of the video bit is ten seconds. For example, the predetermined times are used adjustable through the client-side user interface.

For example, the number of video bits created by a user during the play of a video is unrestricted. That is, as the video is played the user can make a selection at any point and a video bit is created base on the point in the video the selection is made continuously until the end of the video is reached.

For example, each video bit is automatically stored on the client-side personal computing device as well as uploaded to the application's server-side cloud-based storage where each video bit is organized in its own folder hierarchy, linked to the user's application identifier, and time ordered in a first-in basis. For example, the video bit residing either in the client or in the server-side cloud-based storage can be edited. The editing features available include, for example, adding text, slow motion, fast motion, adding music, grouping video bits to create a series of video bits (video bit stream), adding emoticons, adjusting colors, adding shapes or objects, adding pictures, and any other digital visual editing effect, adjusting length of the video bit and so on. For example, the user can optionally upload any additional client-side edited video to the server to be stored and utilized with the stored video bits. For example, based on a user identifier, all uploaded video bits can be linked to a user's feed settings so that there is automatic distribution of video bits to a community of users who have been authorized to receive and view the video bits of the user.

For example, an external input interface receives and reads various media, such as a solid state drive, a flash drive, a USB drive, a memory stick, and any other media that can store corresponding original video for access into a user's computing device. This allows a client-side video bit processing system to begin creating video bits.

Similarly, for example, an external system can be used to convert film based video into a digital format for access into a user's computing device. This also allows a client-side video bit processing system running on the user's computing device to begin creating video bits.

Features from any of the above-mentioned embodiments may be used in combination with one another in accordance with the general principles described herein. These and other embodiments, features, and advantages are more fully understood from the following detailed description in conjunction with the accompanying drawings and claims.

The present disclosure is generally directed to methods for automated creation of video bits. As is explained in greater detail below, optimizing the process of extracting video bits from a full length original video enables a user to be assisted in the creation of video bits quickly and automatically. The video bits can then be automatically distributed to a community of viewers authorized to view the video bits. Embodiments of the instant disclosure may also provide various other advantages and features, as discussed in greater detail below.

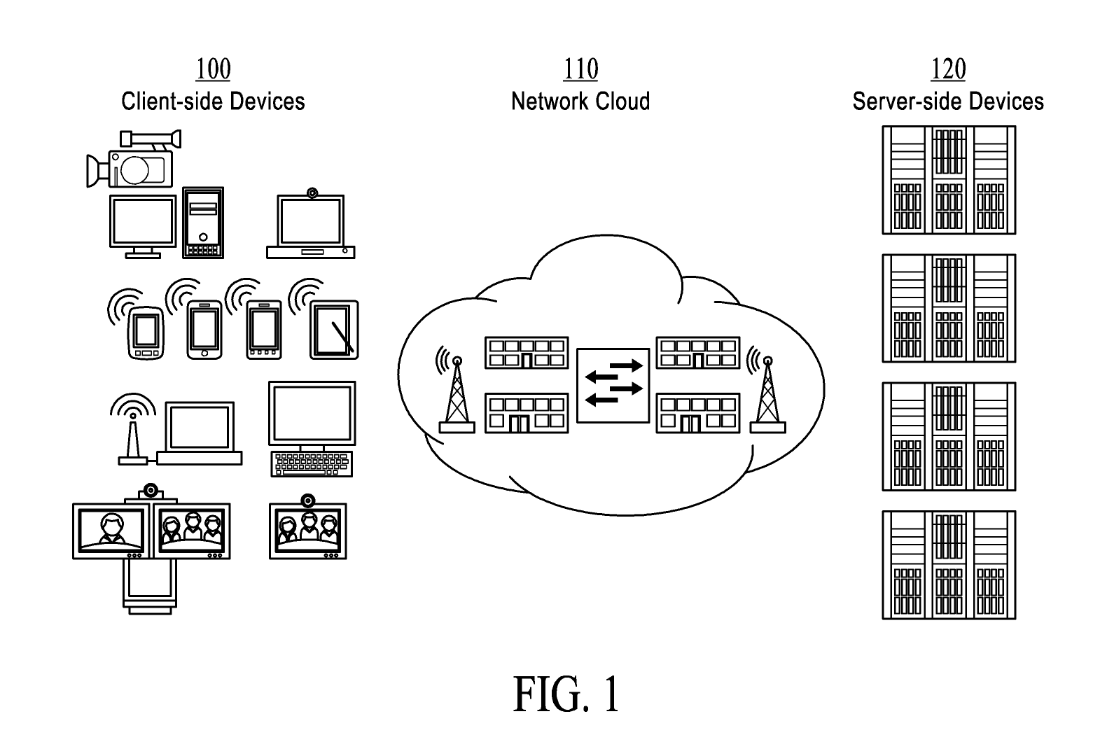

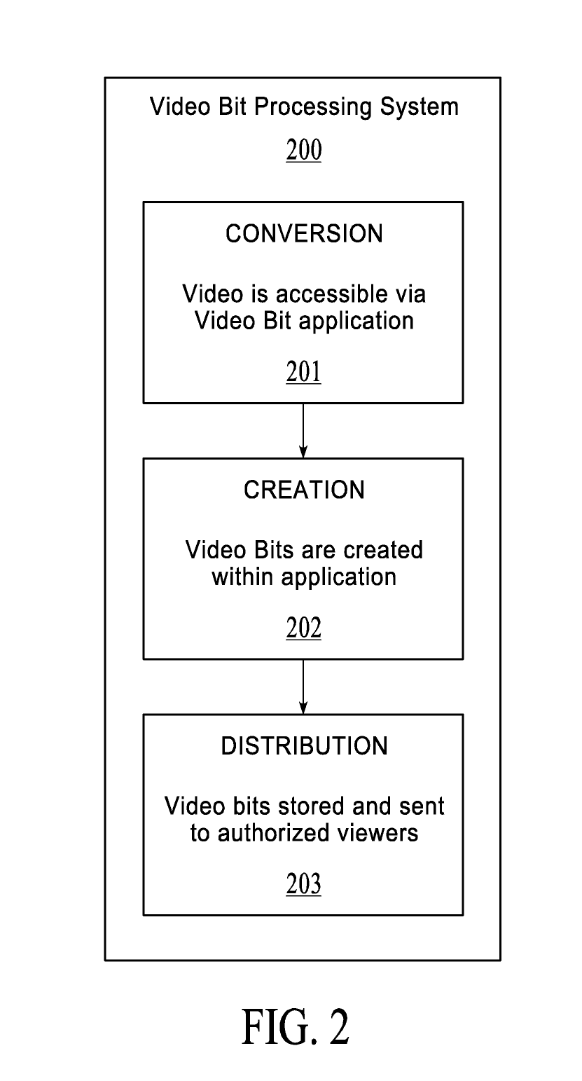

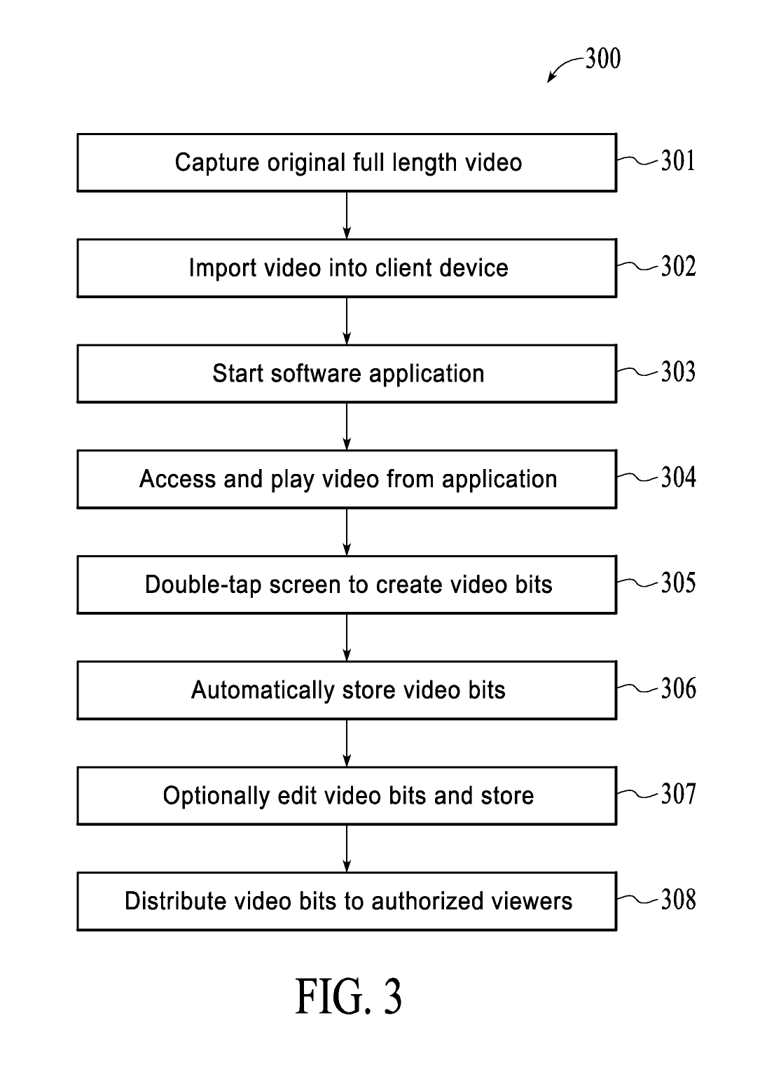

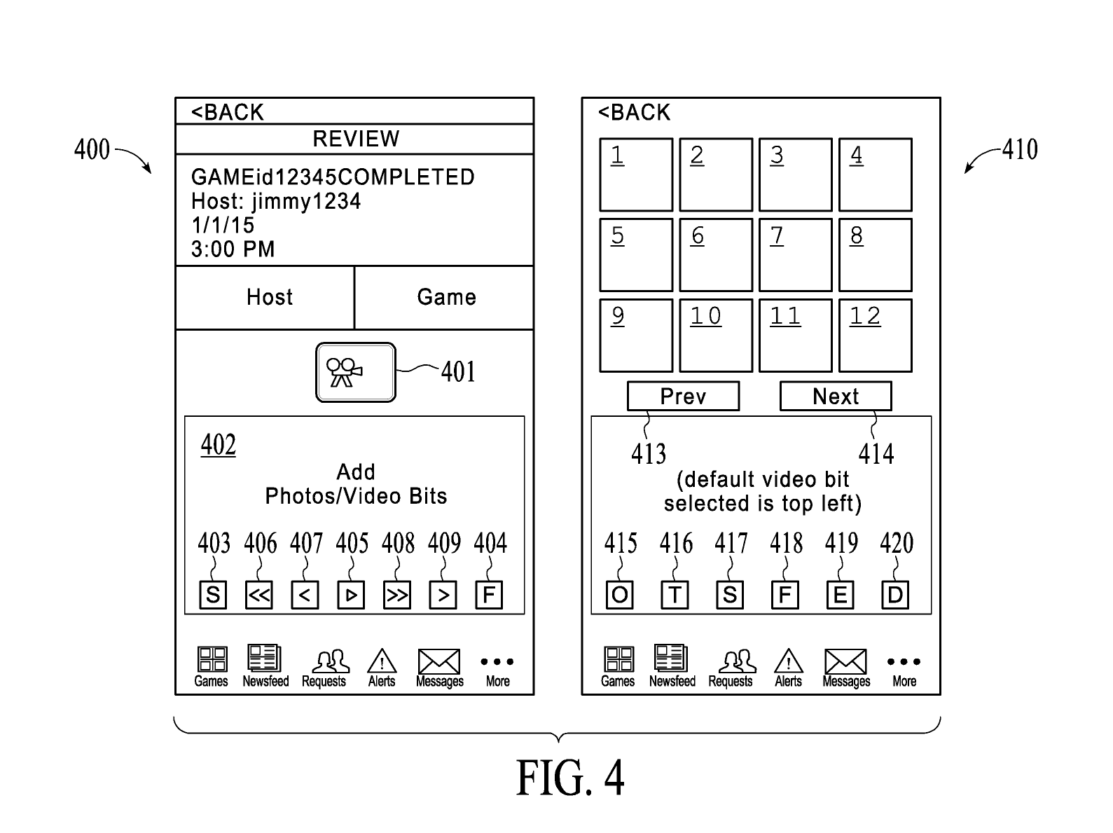

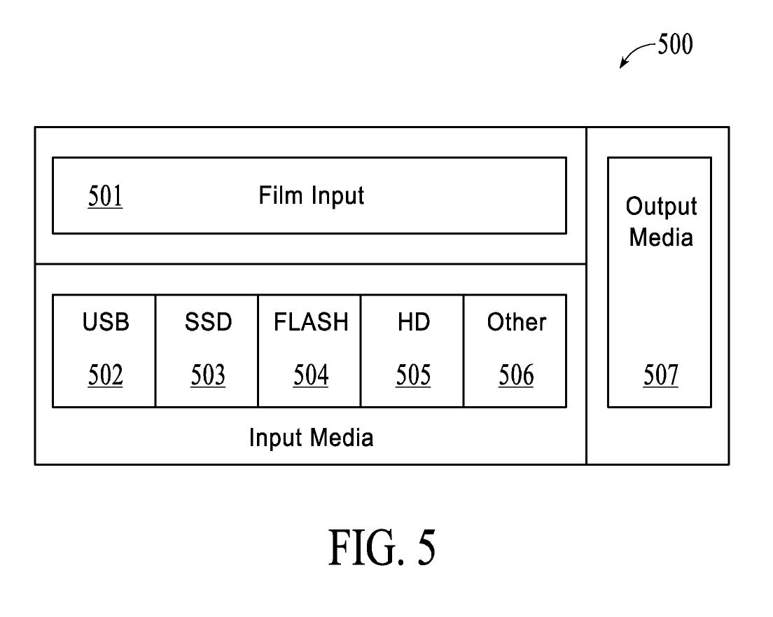

The following describes, with reference to FIG. 1, a set of network and computing elements that enable video bit conversion, creation and distribution. FIG. 2 provides the principal form of functional blocks for video conversion, video bit creation and video bit distribution. FIG. 3 is a process diagram for video conversion, video bit creation and video bit distribution. FIG. 4 provides an example of a client-side software user interface application implementations that provide functionality and a user interface layout. FIG. 5 shows a system that provides conversion of digital or filmed video so that it can interact with the client-side video bit processing system when such video is in a format that cannot be used by a user's personal computing device.

FIG. 1 is a block diagram network architecture of an exemplary method for enabling software controlled automation for converting, creating and distributing video bits. Client-side personal computing devices 100 provide the users the ability to interface with the video bit processing system. Embodiments of client-side personal computing devices 100 include, but are not limited to, smart phones, tablet computers, desktop computers, and any other device that is able to accept and process digital video. For video that is in a format that cannot be utilized by a client-side video bit processing system running within client-side personal computing devices 100, an additional system 500 (shown in FIG. 5), as discussed below, can be utilized. System 500 provides services that convert non-digitized video into a digital format such as, but not limited to, WMV, Zune, MSMP4, MP4, MOV, MPEG2, MPEG1, DVD-NTSC, DVD-PAL, MPEG4, MSMPEG4, DivX, FLV, SWF, 3GP High and 3GP Low; and in parallel converts associated audio into MP3, AAC and WAV. Any other protocols which may have not been explicitly stated can also be supported.

Network cloud 110 is used to enable communication between client-side personal computing devices 100 and server-side devices 120. Network cloud 110 may at times undergo technological change but it is assumed that client-side and server-side devices interoperate seamlessly. Network cloud services are managed by a third party operator and it is assumed such services are operating with 100% availability.

Server-side devices 120 provide storage and user identifiers such that video can be stored and organized for identified users. Once video bits are uploaded to one of server-side devices 120, the server-side device 129 acknowledges and recognizes security settings. The security settings enable user peers, with approved authorization, to access video bits from the user creator. The instant client-side personal computing devices 100, network cloud 110 and server-side devices 120 interoperate and establish a communication link so that the video bit processing system within client-side personal computing devices 100 can convert, create and distribute video bits.

FIG. 2 is a functional flow diagram illustrating the converting, creating and distributing of video bits. Video bit processing system 200 is an application that has components running on a server (service side components) and has components that run on a user's personal computing device (client-side components). Video bit processing system 200 has primary functions that are separated into three distinct parts: a conversion block 201, a creation block 202 and a distribution block 203.

Captured video is often stored on a physical medium, such as film, or electronically in digital format. When stored digitally on a client-side device (i.e., a user's personal computing device), video bit processing system 200 is able to interact with such video instantly as long as the memory device is accessible. However, when on film, video must be converted into a digital format. A Conversion system 500 (shown in FIG. 5) provides an intermediate step that facilitates conversion block 201. Once video is made accessible by video bit processing system 200, an embedded real time stamp data is recognized by video bit processing system 200. This allows the beginning of a video bit creation process within creation block 202.

Creation block 202 provides for creation of a distinct video bit. Original video is played and displayed to a user. Real time stamp data is embedded within the original video. During play of the video, the user can make a selection, for example by double-tapping a client-device selection tool (e.g., a mouse, touch-screen, or keyboard). As a result of this user selection creation block 202 creates two distinct time stamps. The first time stamp is an end time which marks the time within the original video where the user makes the selection. The second time stamp is a start time which occurs a predetermined length of time before the end time. For example, a default value for the predetermined length of time is 10 seconds. For example, the user can vary the default value. The video between start and end times is considered the video bit. Creation block 202 saves the video bit within the current client computing device of client-side personal computing devices 100 and, for example, stores a copy of the video bit on the current server side device 120. The creation process can be done repeatedly to create additional video bits.

When video bits have been created, a user has the option to edit the video bits. The editing can include, for example, adding text, slow motion, fast motion, adding music, grouping video bits to create a series of video bits (video bit stream), adding emoticons, adjusting colors, adding shapes or objects, adding pictures, and any other digital visual editing effect. Edited video bits have the option to then be uploaded to server-side storage of server side device 120.

Within server side device 120, video bit processing system 200 allows a user to, for example, arrange, manage and create video bit streams as well as to delete video bit streams. To support this functionality, video bits are organized and identified in relation to a user on an event relation, first-in basis. For example, a user creates video bits related to event Y at instant Z. When the user, makes a user selection to create video bit Z, video bit Z is stored on local memory of client-side personal computing device 100 and server memory of server side device 120. Video bit processing system 200 automatically creates folder Y to reference event Y at instant Z on both client-side personal computing devices 100 and server side device 120. When each subsequent video bit Z+1, Z+2, Z+N is created, the created video bit is stored in the same folder Y. If video for event W were to be used, corresponding to a different original video, video bit processing system 200 automatically creates the next folder Y+1 and restarts at instant Z. In all cases, the user has the option to rename and delete video bits. Video bit naming may also include pre-words that use a folder-instant convention as defined by video bit processing system 200. Such words, for example, would then name the video bit as “folder_event_Z” or similar nature and store under a general folder. While the folder and naming conventions are susceptible to various modifications and alternative forms, the definitions shown are by way of example. Actual implementation of the folder and video bit will vary across user types.

Distribution block 203 occurs based on the user's publishing settings. For example, the user can authorize immediate distribution to all users on video bit processing system 200. Alternatively, the user can authorize distribution to a select group of peers by providing viewing rights to them alone. Alternatively, the user can maintain privacy by only allowing the user creator to view the video bits. In all instances, distribution settings are stored on the server-side of distribution block 203, where video bit processing system 200 recognizes such settings and acts as the gating device on client-side personal computing device 100.

FIG. 3 is an application process flow for an exemplary method for software controlled automation for converting, creating and distributing video bits. In a capture block 301, the user records video. This could be through film or digital format. If recorded video cannot instantly communicate with video bit processing system 200, the user must covert the video into a readable format and then import into client-side personal computing device 100 as illustrated by a block 302. In some instances, system 500 is required to optimize the conversion process. The user then starts application operating system software as illustrated by a block 303. Through video bit processing system 200, video is played from a viewable area as illustrated by a block 304. As illustrated by a block 305, to create a video bit, the user makes a selection (e.g., double-taps the viewable area) using a selection tool, such as a mouse, a touch-screen or a keyboard of client-side personal computing device 100. Alternative to a double-tap, other selection actions may be used such as a single tap or a selection of a predetermined key on a keyboard. When this selection action occurs, as illustrated by a block 306, video bit processing system 200 automatically stores video bits into client-side and server-side memory. The user can then edit video bits prior to general distribution, as illustrated by a block 307. Based on the user security settings, video bits are then distributed through video bit processing system 200, as illustrated by a block 308.

FIG. 4 shows examples of client-side application display screen views for an exemplary method for software controlled automation for converting, creating and distributing video bits. Display screens are shown as examples only and the actual implementation may differ from what is depicted. A display screen 400 shows event A and the user would like to access video from their computing device to create video bits related to event A. Selecting through single tapping a computing device viewable area 402, original length video is playable on that viewable area using play button 405. Video navigation buttons 406, 407, 408 and 409 allow time movement within the video. While playing, if the user makes a selection (e.g., double-taps viewable area 402) video bit D is created by using end-time at the instant of a double-tap and a user defined time value (default 10 seconds) to set the start time of the video bit, 10 seconds prior to the double-tap. With start and end times defined, video bit processing system 200 stores the video bit locally on the user's client-side personal computing device 100 and optionally on the memory of server side device 120. Video bit button 401 provides user access to all video bits within client and server-side memory and an example of the display screen-view is shown in 410.

Display screen 410 shows video bits 1-12, navigation buttons 413 and 414, operational buttons 415-420. The display screen shown in FIG. 4 is an example only and implementations will vary. Viewable area 402 is filled with the original full length video by default or by a video bit. If the user would like to re-organize the current order, the user simply selects video by holding down the selection button and moving it to the desired location. When this occurs, the order automatically updates. For example, if video bit 5 were to move to the location of video bit 1, the new order would be video bit 5 is in the old location of video bit 1 and video bit 1 is in the old location of video bit 2 with the locations of all remaining video bits adjusting accordingly. On the other hand, if video bit 1 were to move to video bit 5, the new order would be video bit 2 is in the old location of video bit 1 and video bit 1 is in the old location of video bit 5 with the locations of all remaining video bits adjusting accordingly. Navigational buttons allow movement between video ranges. For example, selecting a Next button 414 would allow the user to access video bits 13-24 (not shown). If a Previous button 413 is selected, the user moves backward down the selection process. When in folder tree, the user is able to see all events in storage. Once a video bit is selected, the video is played in viewable area 402. The video can then be subjected to operational buttons 415-420. Button O “Order” 415 allows the user to select where in the order currently selected video bit should reside. The user types order number into the field. Button T “Trim” 416 allows the user to move start and end times by typing the exact time into the start or end fields. Button S “Slow-motion” 417 automatically converts the video bit into a slower play rate video bit in reference to time. For example, a −1.5× setting changes a 10 second video to play in 15 seconds. Similarly, a −2.0× setting doubles the play time. Button F “Fast-motion” 418 automatically converts the video bit into a faster play rate video bit in reference to time. For example, a +1.25× setting changes a 10 second video to play in 8 second. Similarly, a +2.0× setting will half the play time. Button E “Effects” 419 brings up a plethora of video editing effects, such as, but not limited to, adding text, adding music, grouping video bits to create a series of video bits (video bit stream), adding emoticons, adjusting colors, adding shapes or objects, adding pictures, and any other digital visual editing effect.

For example, when adding text, the user selects an area where text will be added to the video bit and types words or sayings in the user-selected area. For example, when adding music, the user selects a music track to be played in parallel with the video. For example, when the user selects the video bit stream option, a stream of selected video bits can be created so that video bits within the stream of video bits are played in order. For example, when adding emoticons is selected, video bit processing system 200 emoticon library super-imposes emoticon artwork onto a video bit. Additional editing effects include changing or modifying colors seen on a video bit, adding shapes, lines, or graphical objects to a video bit, adding still pictures and super-imposing still pictures onto a video bit, and any other video or sound effect that enhances a video bit. Button D “Delete” removes the video bit from the library and then automatically re-organizes remaining video bits.

FIG. 5 is a system architecture for an exemplary system that provides inputs for video media that automatically interact via system outputs with a user's computing device for software controlled automation for converting, creating and distributing video bits. For example, some videos are created using VHS film technology. This video can be inserted into an input module 501 and through system 500 processing, video is automatically converted to a readable format for video bit processing system 200. Input media 502-506 provide a connection path of various digital memory devices such as, but not limited to, a USB device 502, a solid state drive 503, a flash drive 504, a hard disk drive 505, and any other storage media 506. System 500 then processes input video and converts it into a readable format. Output media 507 instantly interoperates with computing client-side personal computing device 100 to enable video selection to be played through video bit processing system 200. Output media can use, but is not limited to, wireless, wireline, Bluetooth, and any other medium that can allow communication between System 500 and computing client-side personal computing device 100.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

The foregoing discussion discloses and describes merely exemplary methods and implementations. As will be understood by those familiar with the art, the disclosed subject matter may be embodied in other specific forms without departing from the spirit or characteristics thereof. Accordingly, the present disclosure is intended to be illustrative, but not limiting, of the scope, which is set forth in the following claims.

What is claimed is:

1. A computer-implemented comprising:
accessing video content, by a video bit processing system, the video bit processing system having components that operate on a server and on a personal computing device;
converting, by the video bit processing system, the video content to a format recognized by the personal computing device;
playing, by the video bit processing system, the converted video content on a display of the personal computing device; and,
creating a video bit in response to a user selection performed by a user while the video content is playing, wherein an end time for the video bit is based on a selection time in which the user makes the user selection and wherein a beginning time for the video bit is at a time in the video that is a predetermined length of time before the end time.

2. A computer implemented method as in claim 1 additionally comprising:
providing, within the video bit processing system, the ability for a user to edit video bits, including:
providing a window within the display where video bits may be listed so that an order in which the video bits are listed determines an order in which the video bits are successively to be played in a video stream.

3. A computer implemented method as in claim 1 wherein the user selection is communicated to the video bit processing system by the user double-clicking on a selection device while the video content is playing.

4. A computer implemented method as in claim 1 wherein the predetermined length of time is 10 seconds.

5. A computer-implemented method as in claim 1 wherein the predetermined length of time is user adjustable.

6. A computer-implemented method as in claim 1 wherein the video bit is distributed automatically to a predetermined community of authorized viewers.

7. A computer-implemented method as in claim 1 wherein the video is imported into the personal computing device from video captured by the user.

8. A computer implemented method as in claim 1 additionally comprising:
providing, within the video bit processing system, the ability for a user to edit video bits, before distribution of the video bits.

9. A computer implemented method as in claim 1, wherein the personal computing device is one of the following:
a smart phone;
a desktop computer;
a tablet computing device;
a handheld computing device;
a laptop computer.

10. A computer implemented method as in claim 1, additionally comprising:
storing the video bit both on the personal computing device and on the server.

11. A computer implemented method as in claim 1, wherein the end time for the video bit is at the selection time in which the user makes the user selection.

12. A computer-implemented as in claim 1 wherein video bits uploaded by the user to the server are distributed or accessible to a predetermined community of authorized viewers.

13. A conversion system comprising;
an input interface device that receives and reads input media that contains input video in a format that is not compatible with a computing device;
a converter that converts the input video into readable video, the readable video being in an output format that is recognizable by a computing-device; and,
output interface that outputs the readable video into the computing device.

14. A conversion system as in claim 13, wherein:
the input media is of the following:
a Video Home System (VHS) video tape with any VHS variant;
a Betamax video tape;
a reel-to-reel video tape;
a digital versatile disc (DVD);
a mini-DVD;
a micro-MV;
a MiniDV;
a Video8;
a Hi8;
a Digital8;
a 3/4 ″ U-Matic; and
a Betacam.

15. A conversion system as in claim 13, wherein the output format is at least one of the following formats:
Windows Media Video (WMV) data format;
Zune data format;
MOV data format;
Moving Pictures Expert Group (MPEG) 2 data format;
MPEG1 data format;
DVD-NTSC data format;
DVD-PAL data format;
MPEG4 data format;
Microsoft MPEG4 (MSMPEG4) data format;
DivX data format;
Flash Video (FLV) data format;
Shockwave Flash file (SWF) data format;
Third generation partnership (3GP) High data format;
3GP Low data format;
MPEG1 and MPEG2 audio layers (MP3);
Advance audio coding (AAC) data format;
Waveform Audio File (WAV) data format;
MPEG-4 Part 14 (MP4) data format;
MSMP4 data format.

16. A conversion system as in claim 13, wherein:
the output interface is a physical component that allows communication with the computing device and uses at least one of the following protocols:
any variant of IEEE 802.11 wireless protocol;
Third Generation (3G) wireless protocol;
Fourth Generation (4G) wireless protocol;
any next Generation wireless protocol;
any radio protocol;
any mobile data protocol;
any variation of Ethernet protocol;
a protocol for data transfer across coaxial cable;
Universal Serial Bus (USB) protocol;
A protocol for data transfer across an optical fiber;
Any variation of the Synchronous Optical Network (SONET) protocol and any variant;
Bluetooth wireless protocol.
